(19) United States
(12) Patent Application Publication
(10) Pub. No.: US 2010/0181002 A1
(43) Pub. Date: Jul. 22, 2010

(54) TIRE

(76) Inventor: Tatsuya Miyazaki, Hyogo (JP)

Correspondence Address: BIRCH STEWART KOLASCH & BIRCH, PO BOX 747, FALLS CHURCH, VA, 22040-0747, US

(21) Appl. No.: 12/676,571

(22) PCT Filed: Oct. 10, 2008
(86) PCT No.: PCT/JP2008/068448

§ 371 Date: Mar. 4, 2010

(30) Foreign Application Priority Data
Oct. 18, 2007 (JP) 2007-271597
Oct. 3, 2008 (JP) 2008-258545

(51) Int. Cl. B60C 1/00; B60C 9/04; B60C 13/00

(52) U.S. Cl. 152/564

(57) ABSTRACT

It is an object of the present invention to improve both of low rolling resistance and strength of a tire. The present invention provides a tire having a side wall, a case and an inner liner wherein the side wall includes (A) a rubber composition for a side wall including 20 to 45 parts by weight of (A2) filler based on 100 parts by weight of the specific rubber component, the cord of the case is covered with (B) a rubber composition for covering a case cord including 20 to 45 parts by weight of (B2) filler based on 100 parts by weight of (B) the specific rubber component, and the inner liner includes (C) a rubber composition for an inner liner including 15 to 45 parts by weight of (C2) carbon black with a nitrogen adsorption specific surface area of 20 to 45 m²/g based on 100 parts by weight of a rubber component including 35 to 80% by weight of (C1) a butyl rubber.

### TECHNICAL FIELD

The present invention relates to a tire satisfying both of the reduction of rolling resistance and the improvement of tire strength.

### BACKGROUND ART

Conventionally, the low fuel cost of a car has been carried out by reducing the rolling resistance of a tire (the improvement of rolling resistance performance). Request for the low fuel cost of a car has been recently strengthened and more superior low heat build-up property is requested. For example, as a method of reducing the rolling resistance of a tire, there is carried out a method of reducing the loss tangent tan δ of a tread, a side wall, a breaker rubber and a clinch in order by which the amount of the rubber used is much.

As methods of reducing the rolling resistance of tire members, it is described in Japanese Unexamined Patent Publication No. 5-320421 that a polybutadiene modified with tin is used as the rubber component of a rubber composition for a side wall and it is described in Japanese Unexamined Patent Publication No. 2007-161819 that a modified styrene-butadiene rubber by solution polymerization and/or a butadiene rubber modified with tin are used as the rubber component of a rubber composition for covering a carcass are used.

As a method of reducing the loss tangent tan δ of a side wall rubber, there are mentioned a method of reducing the compounding amount of filler, a method of enlarging the particle diameter of carbon black and a method of compounding a modified butadiene rubber, but strength at break is generally lowered. Further, as a method of reducing the loss tangent tan δ of a clinch rubber, there are mentioned a method of reducing the compounding amount of filler, a method of enlarging the particle diameter of carbon black and a method of compounding a modified butadiene rubber, but strength at break is all in all lowered; therefore damage by curbstone and damage at assembling a rim is induced and it causes further the abrasion of rim chafing.

In other words, it is difficult to satisfy both of the reduction of rolling resistance and the improvement of strength at break; therefore there has been no tire having both of low rolling resistance and having superior strength.

### DISCLOSURE OF INVENTION

It is an object of the present invention to provide a tire satisfying both of low rolling resistance and the improvement of tire strength.

The present invention relates to a tire having a side wall, a case and an inner liner wherein the side wall includes (A) a rubber composition for a side wall including 20 to 45 parts by weight of (A2) filler based on 100 parts by weight of a rubber component including 35 to 65% by weight of (A1) a natural rubber and/or an isoprene rubber and 15 to 55% by weight of a modified butadiene rubber, the cord of the case is covered with (B) a rubber composition for covering a case cord including 20 to 45 parts by weight of (B2) filler based on 100 parts by weight of (B) a rubber component including (B1) 50 to 80% by weight of a natural rubber and/or an isoprene rubber and 20 to 45% by weight of at least one diene rubber selected from a group including a modified styrene-butadiene rubber, a styrene-butadiene rubber by solution polymerization, a styrene-butadiene rubber by emulsion polymerization, a modified butadiene rubber and an epoxidized natural rubber, and the inner liner includes (C) a rubber composition for an inner liner including 15 to 45 parts by weight of (C2) carbon black with a nitrogen adsorption specific surface area of 20 to 45 m²/g based on 100 parts by weight of a rubber component including 35 to 80% by weight of (C1) a butyl rubber.

The tire is preferably a tire, wherein the complex elastic modulus E* measured is 2.5 to 3.5 MPa and the loss tangent tan δ is 0.03 to 0.100 at 70° C. of (A) the rubber composition for a side wall, the complex elastic modulus E* measured is 2.5 to 3.5 MPa and the loss tangent tan δ is 0.03 to 0.100 at 70° C. of (B) the rubber composition for case cord, and the complex elastic modulus E* measured is 2.5 to 5.0 MPa and the loss tangent tan δ is 0.05 to 0.185 at 70° C. of (C) the rubber composition for an inner liner.

The tire is preferably for a vehicle or a light autotruck.

### BEST MODE FOR CARRYING OUT THE INVENTION

The tire of the present invention has a side wall including (A) a rubber composition for a side wall including a specific composition, a case covering a cord with (B) a rubber composition for covering the case cord including a specific composition and an inner liner including (C) a rubber composition for an inner liner including a specific composition.

The rubber composition for a side wall (A) of the present invention includes the specific rubber component (A1) and filler (A2).

The rubber component (A1) includes a natural rubber (NR) and/or an isoprene rubber (IR) and a modified butadiene rubber (modified BR).

The NR is not specifically limited, those usually used in the rubber industry can be used and specifically, those such as RSS#3 and TSR20 are mentioned.

The IR is not specifically limited and those having been conventionally used in the tire industry can be used.

The content of the NR and/or IR in the rubber component (A1) is at least 35% by weight and preferably at least 40% by weight in the view point that strength at break is superior. Further, the content of NR and/or IR in the rubber component (A1) is at most 65% by weight and preferably at most 60% by weight in the view point that the adequate amount of a modified BR superior in crack resistance can be compounded.

The modified BR is obtained by chemically modifying the terminal of a butadiene rubber and enhancing bonding force between a polymer and carbon black.

The modified BR is obtained by polymerizing 1,3-butadiene by a lithium initiator and then adding a tin compound and further, those in which the terminal of the modified BR molecule is bonded with a tin-carbon bonding are preferable.

The lithium initiator includes lithium compounds such as an alkyl lithium, aryl lithium, vinyl lithium, organic tin lithium and organic nitrogen lithium compound, and lithium metal. The modified BR with high vinyl content and low cis content can be prepared by using the above lithium initiator as the initiator of the modified BR.

The tin compound includes tin tetrachloride, butyltin trichloride, dibutyltin dichloride, dioctyltin dichloride, tributyltin chloride, triphenyltin chloride, diphenyldibutyltin, triphenyltin ethoxide, diphenyldimethyltin, ditolyltin chloride, diphenyltin dioctanoate, divinyldiethyltin, tetrabenzyltin, dibutyltin di-stearate, tetra-allyltin and p-tributyltin styrene. These tin compounds may be used alone and at least 2 kinds may be used in combination.

The content of a tin atom in the modified BR is preferably at least 50 ppm and more preferably at least 60 ppm. When the content of a tin atom is less than 50 ppm, effect for promoting the dispersion of carbon black in the modified BR is little and tan δ tends to be increased. Further, the content of a tin atom is preferably at most 3000 ppm, more preferably at most 2500 ppm and further preferably at most 250 ppm. When the content of a tin atom exceeds 3000 ppm, the cohesiveness of a kneaded article is bad and edges are not arranged; therefore the extrusion processability of the kneaded article tends to be deteriorated.

The molecular weight distribution (Mw/Mn) of the modified BR is preferably at most 2 and more preferably at most 1.5. When Mw/Mn of the modified BR exceeds 2, the dispersibility of carbon black is deteriorated and tan δ tends to be increased.

The vinyl bond quantity of the modified BR is preferably at least 5% by weight and more preferably at least 7% by weight. When the vinyl bond quantity of the modified BR is less than 5% by weight, it tends to be difficult to polymerize (produce) the modified BR. Further, the vinyl bond quantity of the modified BR is preferably at most 50% by weight and more preferably at most 20% by weight. When the vinyl bond quantity of the modified BR exceeds 50% by weight, the dispersibility of carbon black is deteriorated and tensile strength tends to be lowered.

As the modified BR satisfying above condition, for example, BR1250H manufactured by ZEON Corporation is mentioned.

The content of the modified BR in the rubber component (A1) is at least 15% by weight and preferably at least 20% by weight in the view point that tan δ can be reduced. Further, the content of the modified BR in the rubber component (A1) is at most 55% by weight and preferably at most 50% by weight in the view point that even if the modified BR is compounded much more, effect of reducing tan δ is saturated.

Further, an epoxidized natural rubber (ENR) may be further compounded in the rubber component (A1). As the ENR, a commercially available ENR may be used and an ENR obtained by epoxidizing the NR may be used. A method of epoxidizing the NR is not specifically limited and can be carried out using methods such as a chlorohydrin method, a direct oxidation method, a hydrogen peroxide method, an alkylhydroperoxide method and a peracid method. As the peracid method, for example, methods such as a method of reacting organic peracids such as peracetic acid and performic acid are mentioned.

The epoxidization ratio of the ENR is preferably at least 10% by mol and more preferably at least 20% by mol. When the epoxidization ratio of the ENR is less than 10% by mol, reversion is great and crack growth resistance tends to be lowered. Further, the epoxidization ratio of the ENR is preferably at most 60% by mol and more preferably at most 55% by mol. When the epoxidization ratio of the ENR exceeds 60% by mol, processability such as mixed compound and sheet processability tends to be lowered.

The ENR satisfying the above condition is not specifically limited, but ENR 25 and ENR 50 (manufactured by Kumpulan Guthrie Berhad) are mentioned. The ENR may be used alone and at least 2 kinds may be used in combination.

The content of the ENR in the rubber component (A1) is preferably at least 20% by weight and more preferably at least 30% by weight in the view point that the crack growth resistance is superior. Further, the content of the ENR in the rubber component (A1) is at most 80% by weight and preferably at most 70% by weight in the view point that strength at break is superior.

As the filler (A2), for example, fillers such as carbon black, silica and calcium carbonate are mentioned. These may be used alone and at least 2 kinds may be used in combination. Among these, carbon black is preferably used in the view point that strength at break, ozone resistance and weather resistance is superior.

The compounding amount of the filler (A2) is at least 20 parts by weight based on 100 parts by weight of the rubber component (A1) and preferably at least 23 parts by weight in the view point that strength at break, sheet processability and extrusion processability is superior. Further, the compounding amount of the filler (A2) is at most 45 parts by weight based on 100 parts by weight of the rubber component (A1) and preferably at most 40 parts by weight in the view point that tan δ can be reduced.

As the carbon black, one having the nitrogen adsorption specific surface area (N₂SA) of at least 20 m²/g is preferable and one having that of at least 30 m²/g is more preferable in the view point that strength at break and processability is superior. Further, as the carbon black, one having N₂SA of at most 100 m²/g is preferable and one having that of at most 80 m²/g is more preferable in the view point that the tan δ can be reduced.

In the rubber composition for a side wall (A) of the present invention, there can be also suitably compounded compounding agents conventionally used in the tire industry such as, for example, a vulcanizing agent such as sulfur, a vulcanization accelerators, zinc oxide, an antioxidant, aromatic oil, stearic acid and wax, in addition to the above rubber component (A1) and filler (A2).

The rubber composition for a side wall (A) of the present invention is preferably a complex elastic modulus E* measured at 70° C. of at least 2.5 MPa and more preferably at least 2.7 MPa in the view point that strength at break is superior. Further, the rubber composition for a side wall (A) is preferably a complex elastic modulus E* measured at 70° C. of at most 3.5 MPa and more preferably at most 3.3 MPa in the view point that it tends to be easily bent during loading and the rolling resistance is low.

For the rubber composition for a side wall (A) of the present invention, the lower the loss tangent tan δ measured at 70° C. is, the more preferable it is. But the lower limit value is 0.03. Further, for the rubber composition for a side wall (A), the loss tangent tan δ measured at 70° C. is preferably at most 0.100 and more preferably at most 0.090 in the view point that low tan δ is superior in low heat build-up property and low rolling resistance.

Herein, the complex elastic modulus E* and the loss tangent tan δ measured at 70° C. means complex elastic modulus (E*) and loss tangent (tan δ) that was measured under the conditions of a temperature of 70° C., a frequency of 10 Hz, an initial strain of 10% and a dynamic strain of 2% using a viscoelastic spectrometer.

The rubber composition for covering case cord (B) of the present invention includes the specific rubber component (B1) and filler (B2).

The rubber component (B1) includes a natural rubber (NR) and/or an isoprene rubber (IR) and at least one diene rubber selected from a group including a modified styrene-butadiene rubber (modified-SBR), a styrene-butadiene rubber (S-SBR) by solution polymerization, styrene-butadiene rubber (E-SBR) by emulsion polymerization, modified butadiene rubber (modified-BR) and epoxidized natural rubber (ENR).

The NR is not specifically limited, those usually used in the rubber industry can be used and specifically, those such as RSS#3 and TSR20 are mentioned.

Further, the IR is not specifically limited and those having been conventionally used in the tire industry can be used.

The content of the NR and/or IR in the rubber component (B1) is at least 50% by weight and preferably at least 55% by weight in the view point that strength at break is superior. Further, the content of the NR and/or IR in the rubber component (B1) is at most 80% by weight and preferably at most 75% by weight in the view point that the adequate amount of an SBR or ENR superior in durability at high temperature (150 to 250° C.) and reversion property is compounded.

As the S-SBR and E-SBR, those having conventionally used in the tire industry can be used and specifically, an SBR1502 manufactured by JSR Co., Ltd. as the E-SBR and Nipol NS116 manufactured by ZEON Corporation as the S-SBR are mentioned.

The modified SBR is a polymer introducing a modified group having strong bonding force with silica or carbon black at polymer terminals or in polymer chains.

As the modified SBR, those having little bonded styrene amount such as HPR340 manufactured by JSR Co., Ltd. are preferable.

The bonded styrene amount of the modified SBR is preferably at least 5% by weight and more preferably at least 7% by weight in the view point that the reversion property in the rubber compounding is superior. Further, the bonded styrene amount of the modified SBR is preferably at most 30% by weight and more preferably at most 20% by weight in the view point that low heat build-up property is superior.

The modified SBR includes a modified SBR by emulsion polymerization (modified E-SBR) and a modified SBR by solution polymerization (modified S-SBR), but the modified S-SBR is preferable because low fuel cost can be improved by strengthening the bond of polymer chains with silica and reducing the tan δ.

As the modified SBR, those coupled with tin and silicon are preferably used. As a method of coupling the modified SBR, there are mentioned methods such as a method of reacting an alkali metal (such as Li) and an alkali earth metal (such as Mg) at the molecular chain terminal of the modified SBR with tin halide and silicon halide in accordance with a usual method.

The modified SBR is a (co)polymer obtained by (co)polymerizing a conjugated diolefin alone or a conjugated diolefin with an aromatic vinyl compound and has preferably a primary amino group and an alkoxysilyl group.

The primary amino group may be bonded with either of a polymerization initiation terminal, a polymerization termination terminal, a polymer main chain and a side chain, but it is preferable that it is introduced at the polymerization initiation terminal or polymerization termination terminal in the view point that energy extinction is suppressed from a polymer terminal and hysteresis loss property can be improved.

The weight average molecular weight (Mw) of the modified SBR is preferably at least one million and more preferably at least 1.2 million in the view point that adequate fracture property is obtained. Further, the Mw of the modified SBR is preferably at most 2 million and more preferably at most 1.8 million in the view point that rubber viscosity is adjusted and kneading process can be easily carried out.

When the modified SBR, S-SBR and E-SBR are compounded in the rubber component (B1), the contents of the modified SBR, S-SBR and E-SBR are at least 20% by weight and preferably at least 25% by weight in the view point that reversion property and durability is superior. Further, the contents of the modified SBR, S-SBR and E-SBR in the rubber component (B1) are at most 45% by weight and preferably at most 42% by weight in the view point that the adequate amount of the NR and/or IR superior in strength at break is compounded.

As the modified BR used as the rubber component (B1), the above-described modified BR can be preferably used.

The content of the modified BR in the rubber component (B1) is preferably at least 10% by weight and more preferably at least 15% by weight in the view point that the crack growth resistance is superior and the tan δ can be reduced. Further, the content of the modified BR in the rubber component (B1) is preferably at most 45% by weight and more preferably at most 40% by weight in the view point that the reversion property and strength at break is superior.

In the rubber component (B1), the total of contents of the modified SBR, S-SBR and E-SBR and the modified BR is at least 20% by weight because the modified SBR, S-SBR and E-SBR superior in reversion property and thermal stability and the modified BR superior in crack growth resistance are compounded.

Further, as the ENR used for the rubber component (B1), the above ENR can be preferably used.

When the ENR is compounded, the content of the ENR in the rubber component (B1) is at least 20% by weight and preferably at least 30% by weight in the view point that the reversion property is superior. Further, the content of the ENR in the rubber component (B1) is at most 45% by weight and preferably at most 40% by weight in the view point that strength at break is superior.

With respect to the contents of the modified SBR, S-SBR and E-SBR, modified BR and ENR in the rubber component (B1), the total of contents of these rubber components is 20 to 45% by weight.

The filler (B2) includes, for example, carbon black, silica and calcium carbonate. These may be used alone and at least 2 kinds may be used in combination. Among these, carbon black is preferably used in the view point that strength at break is superior and tan δ can be reduced.

The compounding amount of the filler (B2) is at least 20 parts by weight based on 100 parts by weight of the rubber component (B1) and preferably at least 23 parts by weight in the view point that strength at break is superior. Further, the compounding amount of the filler (B2) is at most 45 parts by weight based on 100 parts by weight of the rubber component (B1) and preferably at most 40 parts by weight in the view point that the tan δ can be reduced.

As the carbon black, those having N₂SA of at least 20 m²/g are preferable and those having at least 30 m²/g are more preferable in the view point that strength at break is superior. Further, as the carbon black, those having N₂SA of at most 100 m²/g are preferable and those having N₂SA of at most 90 m²/g are preferable in the view point that the tan δ can be reduced.

In the rubber composition for covering a case cord (B) of the present invention, there can be suitably compounded compounding agents generally used in the tire industry such as, for example, a vulcanizing agent such as sulfur, a vulcanization accelerators, zinc oxide, an antioxidant, aromatic oil and stearic acid, in addition to the above rubber component (B1) and filler (B2).

The rubber composition for covering a case cord (B) of the present invention is preferably a complex elastic modulus E* measured at 70° C. of at least 2.5 MPa and more preferably at least 2.7 MPa in the view point that strength at break is superior. Further, the rubber composition for covering a case cord (B) is preferably a complex elastic modulus E* measured at 70° C. of at most 3.5 MPa and more preferably at most 3.2 MPa in the view point that the rolling resistance is superior.

For the rubber composition for covering a case cord (B) of the present invention, the lower the loss tangent tan δ measured at 70° C. is, the more preferable it is, but the lower limit value is usually 0.03. Further, for the rubber composition for covering a case cord (B), the loss tangent tan δ measured at 70° C. is preferably at most 0.100 and more preferably at most 0.090 in the view point that the rolling resistance is superior.

Herein, the complex elastic modulus E* and the loss tangent tan δ measured at 70° C. means complex elastic modulus (E*) and loss tangent (tan δ) that was measured under the conditions of a temperature of 70° C., a frequency of 10 Hz, an initial strain of 10% and a dynamic strain of 2% using a viscoelastic spectrometer.

The case cord of the present invention is either of a case steel cord or a case textile cord.

The case steel cord means a steel cord covered with the rubber composition for covering a case (B), using the rubber composition for covering a case cord (B) as a rubber covering a case cord.

Further, the case textile cord means a textile cord covered with the rubber composition for covering a case (B), using the rubber composition for covering a case cord (B) as a rubber covering a case. In this case, the textile cord is those obtained by raw materials such as polyester, nylon, rayon, polyethylene terephthalate and aramid. Among these, polyester is preferably used as a raw material in the view point that it is superior in thermal stability and cheap.

The rubber composition for an inner liner (C) of the present invention includes a butyl rubber (C1) and carbon black (C2) with a nitrogen adsorption specific surface area of 20 to 45 m²/g.

The butyl rubber includes, for example, a butyl rubber (IIR), brominated butyl rubber (Br-IIR) and chlorinated butyl rubber (Cl-IIR). Among these, Cl-IIR is preferable in the view point that it is hardly scorched and extensibility is good; therefore processability is superior.

The content of the butyl rubber in the rubber component (C1) is at least 35% by weight and preferably at least 45% by weight in the view point that air permeation resistance and the crack growth resistance can be maintained. Further, the content of the butyl rubber in the rubber component (C1) is at most 80% by weight and preferably at most 75% by weight in the view point that tan δ is made suitable, heat build-up is suppressed and effect for suppressing air permeation is saturated, even if it is excessively compounded.

Further, the rubber component (C1) can include further a natural rubber (NR) and/or an isoprene rubber (IR), a butadiene rubber (BR) or a modified butadiene rubber (modified BR). The above-described modified BR can be preferably used as the modified BR.

The content of the NR and/or IR or BR in the rubber component (C1) is preferably at least 10% by weight and more preferably at least 20% by weight in the view point that processability, the unevenness of mixed compound and sheet edge flatness is superior. Further, the content of the NR and/or IR or BR in the rubber component (C1) is preferably at most 70% by weight and more preferably at most 60% by weight in the view point that air permeation property is superior.

The rubber composition for an inner liner (C) includes carbon black (C2) having a nitrogen adsorption specific surface area (N₂SA) of 20 to 45 m²/g.

The N₂SA of specific carbon black (C2) is at least 20 m²/g and preferably at least 25 m²/g in the view point that adequate strength is obtained and sheet processing is superior. Further, the N₂SA of carbon black is at most 45 m²/g and preferably at most 40 m²/g in the view point that the rolling resistance of a tire is suppressed.

The compounding amount of the specific carbon black (C2) is at least 15 parts by weight based on 100 parts by weight of the rubber component (C1) and preferably at least 20 parts by weight in the view point that strength at break is superior. Further, the compounding amount of carbon black is at most 45 parts by weight based on 100 parts by weight of the rubber component (C1) and preferably at most 40 parts by weight in the view point that the tan δ is suppressed (low heat build-up property) and sheet processability is superior.

The rubber composition for an inner liner (C) of the present invention can further include silica (C3).

The N₂SA of silica (C3) is preferably at least 40 m²/g and more preferably at least 50 m²/g in the view point that strength at break is superior. Further, the N₂SA of silica is preferably at most 200 m²/g and more preferably at most 180 m²/g in the view point that effect (low heat build-up property) of suppressing the tan δ is superior.

As the silica (C3) used for the present invention, Ultrasil VN3 available from Degussa Corporation, Z115GR available from Rhodia S. A. and Ultrasil 360 available from Degussa Corporation are specifically mentioned.

The compounding amount of the silica (C3) is preferably at least 10 parts by weight based on 100 parts by weight of the rubber component (C1), more preferably at least 15 parts by weight and further preferably at least 20 parts by weight in the view point that processability to a sheet and the dispersibility of silica is superior. Further, the compounding amount of the silica (C3) is preferably at most 45 parts by weight based on 100 parts by weight of the rubber component (C1) and more preferably at most 40 parts by weight in the view point that low heat build-up property is superior.

When the silica (C3) is used, a silane coupling agent is preferably used in combination.

The silane coupling agent is not specifically limited, and those having been conventionally compounded in a rubber composition together with silica in the tire industry can be used. Specifically, there are mentioned sulfides such as bis(3-triethoxysilylpropyl)tetrasulfide, bis(2-triethoxysilylethyl)tetrasulfide, bis(4-triethoxysilylbutyl)tetrasulfide, bis(3-trimethoxysilylpropyl)tetrasulfide, bis(2-trimethoxysilylethyl)tetrasulfide, bis(4-trimethoxysilylbutyl)tetrasulfide, bis(3-triethoxysilylpropyl)trisulfide, bis(2-triethoxysilylethyl)trisulfide, bis(4-triethoxysilylbutyl)trisulfide, bis(3-trimethoxysilylpropyl)trisulfide, bis(2-trimethoxysilylethyl)trisulfide, bis(4-trimethoxysilylbutyl)trisulfide, bis(3-triethoxysilylpropyl)disulfide, bis(2-triethoxysilylethyl)disulfide, bis(4-triethoxysilylbutyl)disulfide, bis(3-trimethoxysilylpropyl)disulfide, bis(2-trimethoxysilylethyl)disulfide, bis(4-trimethoxysilylbutyl)disulfide, 3-trimethoxysilylpropyl-N,N-dimethylthiocarbamoyltetrasulfide, 3-triethoxysilylpropyl-N,N-dimethylthiocarbamoyltetrasulfide, 2-triethoxysilylethyl-N,N-dimethylthiocarbamoyltetrasulfide, 2-trimethoxysilylethyl-N,N-dimethylthiocarbamoyltetrasulfide, 3-trimethoxysilylpropylbenzothiazolyltetrasulfide, 3-triethoxysilylpropylbenzothiazoltetrasulfide, 3-triethoxysilylpropyl methacrylate mono sulfide and 3-trimethoxysilylpropyl methacrylate monosulfide; mercapto series such as 3-mercaptopropyltrimethoxysilane, 3-mercaptopropyltriethoxysilane, 2-mercaptoethyltrimethoxysilane and 2-mercaptoethyltriethoxysilane; vinyl series such as vinyl triethoxysilane and vinyl trimethoxysilane; amino series such as 3-aminopropyltriethoxysilane, 3-aminopropyltrimethoxysilane, 3-(2-aminoethyl)amino propyltriethoxysilane and 3-(2-aminoethyl)aminopropyltrimethoxysilane; glycidoxy series such as γ-glycidoxypropyltriethoxysilane, γ-glycidoxypropyltrimethoxysilane, γ-glycidoxypropylmethyldiethoxysilane and γ-glycidoxypropylmethyldimethoxysilane; nitro series such as 3-nitropropyltrimethoxysilane and 3-nitropropyltriethoxysilane; chloro series such as 3-chloropropyltrimethoxysilane, 3-chloropropyltriethoxysilane, 2-chloroethyltrimethoxysilane and 2-chloroethyltriethoxysilane. These silane coupling agents may be used alone or at least 2 kinds may be used in combination. Among these, bis(3-triethoxysilylpropyl)tetrasulfide and bis(3-triethoxysilylpropyl)disulfide are preferably used.

When the silane coupling agent is compounded, the content of the silane coupling agent is preferably at least 6 parts by weight based on 100 parts by weight of the silica (C3) and more preferably at least 8 parts by weight in the view point that the processability and heat build-up property is superior. Further, the content of the silane coupling agent is preferably at most 12 parts by weight based on 100 parts by weight of the silica (C3) and more preferably at most 10 parts by weight in the view point that when the silane coupling agent is excessively compounded, excessive coupling agent releases sulfur and the rubber is excessively cured, therefore strength at break is lowered and cost is heightened.

Further, mica (C4) can be further included in the rubber composition for an inner liner (C) of the present invention.

The mica (C4) includes muscovite (white mica), phlogopite (gold mica) and biotite (black mica), and it may be used alone and at least 2 kinds may be used in combination. Among these, phlogopite is preferable because flat rate is larger than other mica and air shutoff effect is superior.

The average particle diameter of the mica (C4) is preferably at least 40 μm and more preferably at least 45 μm in the view point that the adequate improvement effect of air permeation resistance is obtained. Further, the average particle diameter of mica is preferably at most 100 μm and more preferably at most 70 μm in the view point that the generation of crack being starting point as the mica is suppressed and crack due to the flexural fatigue of an inner liner is suppressed. Herein, the average particle diameter of the mica means the average value of the long diameter of mica.

The aspect ratio of the mica (C4) is preferably at least 50 and more preferably at least 55 in the view point that the adequate improving effect of air permeation resistance is obtained. Further, the aspect ratio of the mica (C4) is preferably at most 100 and more preferably at most 70 in the view point that adequate strength is kept and the crack of mica can be suppressed. Herein, the aspect ratio means a ratio (maximum long diameter/thickness) of a maximum long diameter to thickness in mica.

The mica (C4) used in the present invention can be obtained by pulverization methods such as wet pulverization and dry pulverization. The wet pulverization can prepare clean surface and effect of improving the air permeation resistance is slightly high. Further, the dry pulverization is a simple production step and low cost, and respective methods have respective characteristics. They are preferably used separately depending on respective cases.

The content of the mica (C4) is preferably at least 10 parts by weight based on 100 parts by weight of the rubber component (C1) and more preferably at least 30 parts by weight in the view point that the adequate air permeation resistance, heat build-up property and crack growth resistance is obtained as an inner liner and sheet flatness (processability) is superior. Further, the content of the mica (C4) is preferably at most 50 parts by weight based on 100 parts by weight of the rubber component (C1), more preferably at most 45 parts by weight and further preferably at most 40 parts by weight in the view point that the tearing strength of the rubber composition obtained is kept and the generation of crack is suppressed.

In the rubber composition for an inner liner (C) of the present invention, there can be suitably compounded compounding agents conventionally used in the tire industry such as, for example, a vulcanizing agent such as sulfur, a vulcanization accelerators, zinc oxide, an antioxidant, aromatic oil, mineral oil, adhesive resin, wax, stearic acid, pitch coal (Austin black) and calcium carbonate, in addition to the above rubber component (C1), specific carbon black (C2), silica (C3) and mica (C4).

For the rubber composition for an inner liner (C) of the present invention, a complex elastic modulus E* measured at 70° C. is preferably at least 2.5 MPa and more preferably at least 2.7 MPa in the view point that strength at break is superior. Further, for the rubber composition for an inner liner (C), a complex elastic modulus E* measured at 70° C. is preferably at most 5.0 MPa and more preferably at most 4.5 MPa in the view point that the reduction effect of rolling resistance is superior.

For the rubber composition for an inner liner (C) of the present invention, the lower the loss tangent tan δ measured at 70° C. is, the more preferable it is, but its lower limit value is usually 0.05. Further, for the rubber composition for an inner liner (C), the loss tangent tan δ measured at 70° C. is preferably at most 0.185, more preferably at most 0.150 and further preferably at most 0.12 in the view point that the reduction effect of rolling resistance is superior.

In this case, the complex elastic modulus E* and the loss tangent tan δ measured at 70° C. means complex elastic modulus (E*) and loss tangent (tan δ) that was measured under the conditions of a temperature of 70° C., a frequency of 10 Hz, an initial strain of 10% and a dynamic strain of 2% using a viscoelastic spectrometer.

The tire of the present invention is produced by a usual process using the rubber composition for a side wall (A) of the present invention as a side wall, the rubber composition for covering a case cord (B) as the cord for covering a case and the rubber composition for an inner liner (C) as the inner liner. In other words, the rubber composition for a side wall (A) and the rubber composition for an inner liner (C) of the present invention are extruded and processed in match with the shapes of the side wall and inner liner respectively at an uncured stage, a case cord is covered with the rubber composition for covering a case cord (B) to mold the case cord and they are laminated with other tire members on a tire molding machine to form uncured tires. The tires of the present invention can be produced by heating and pressuring the uncured tires in a vulcanization machine.

Further, a tire with high inner pressure (700 to 1000 kPa (7 to 10 kg/cm²)) affects little rolling resistance even if the complex elastic modulus E* of a side wall portion is reduced, but in case of a tire with low inner pressure (at most 300 kPa), the bending of a side wall portion, that is, the complex elastic modulus E* affects the rolling resistance; therefore the tire of the present invention can be preferably used as a tire for an automobile and a tire for light autotruck that are used at low inner pressure (at most 300 kPa).

### EXAMPLES

The present invention is specifically illustrated based on Examples, but the present invention is not limited only to these.

Various chemicals used in Examples and Comparative Examples are illustrated in summary.

Natural rubber (NR): RSS#3.
Modified butadiene rubber (modified BR): Nipol BR1250H (Modified BR,
Lithium initiator: lithium, Content of tin atom: 250 ppm, Mw/Mn: 1.5, Vinyl amount: 10 to 13% by weight) manufactured by ZEON Corporation.
Butadiene rubber (BR): BR150B manufactured by Ube Industries, Ltd.
Epoxidized natural rubber (ENR): ENR25 (epoxidization ratio: 25% by mol) manufactured by Kumpulan Guthrie Berhad.
Styrene-butadiene rubber (E-SBR) by emulsion polymerization: SBR1502 manufactured by JSR Co., Ltd.
Modified styrene-butadiene rubber (modified S-SBR) by solution polymerization: HPR340 (Bonded styrene amount: 10% by weight. Coupling is carried out with alkoxysilane and introduced at a terminal.) manufactured by JSR Co., Ltd.
Butyl rubber: HT-1066 (chlorinated butyl rubber) manufactured by Exxon Mobile Corporation.
Carbon black 1: SHOWBLACK N550 (N₂SA: 41 m²/g) available from CABOT JAPAN K.K.
Carbon black 2: SEAST V (N660, N₂SA: 27 m²/g) available from TOKAI CARBON CO., LTD.
Carbon black 3: SHOWBLACK N330 (N₂SA: 79 m²/g) available from CABOT JAPAN K.K.
Silica 1: Z115Gr (N₂SA: 112 m²/g) available from Rhodia S.A.
Silica 2: Ultrasil 360 (N₂SA: 54 m²/g) available from Degussa Corporation.
Mica: Phlogopite S-200HG (an average particle diameter of 50 μm and an aspect ratio of 55) available from REPCO Inc.
Zinc oxide: GINREI R available from Toho Zinc Co., Ltd.
Stearic acid: TSUBAKI available from NOF Corporation.
Aromatic oil: PROCESS X-140 available from Japan Energy Co., Ltd.
Antioxidant: NOCRAC 6C (N-(1,3-dimethylbutyl)-N-phenyl-p-phenylenediamine) available from OUCHISHINKO CHEMICAL INDUSTRIAL CO., LTD.
Wax: SUNNOC WAX available from OUCHISHINKO CHEMICAL INDUSTRIAL CO., LTD.
Sulfur: 5% Oil Treated Sulfur Powder available from TSURUMI CHEMICAL INDUSTRY CO., LTD.
Insoluble sulfur: Seimisulfur (including 60% of insoluble sulfur by carbon disulfide and an oil content of 10%) available from NIPPON KANRYU Industry Co., Ltd.
Vulcanization accelerator CZ: NOCCELER CZ (N-cyclohexyl-2-benzothiazylsulfenamide) available from OUCHISHINKO CHEMICAL INDUSTRIAL CO., LTD.
Vulcanization accelerator DM: NOCCELER DM (di-2-benzothiazolyl disulfide) available from OUCHISHINKO CHEMICAL INDUSTRIAL CO., LTD.
Vulcanization accelerator TBZTD: Perkacit TBZTD (tetrabenzylthiuram disulfide available from Flexsys Chemicals Sdn. Bhd.)

### Production Examples 1 to 5

### Rubber Compositions for a Side Wall

Chemicals excluding sulfur and a vulcanization accelerator were added and kneaded under the condition of a maximum temperature of 165° C. for 5 minutes with a Banbury mixer according to the compounding prescription shown in Table 1, to obtain kneaded products. Then, sulfur and a vulcanization accelerator were added to the kneaded product obtained, and the mixture was kneaded under the condition of a maximum temperature of 97° C. for 3 minutes with an open roll, to obtain uncured rubber compositions. The uncured rubber compositions obtained were rolled in a sheet shape with a mold and vulcanized by press under the condition of 170° C. for 12 minutes to prepare the vulcanized rubber sheets of Production Examples 1 to 5 (SW1 to 5).

### Production Examples 6 to 9

### Rubber Compositions for Covering a Case Cord

Chemicals excluding sulfur and a vulcanization accelerator were added and kneaded under the condition of a maximum temperature of 165° C. for 5 minutes with a Banbury mixer according to the compounding prescription shown in Table 2, to obtain kneaded product. Then, sulfur and a vulcanization accelerator were added to the kneaded products obtained, and the mixture was kneaded under the condition of a maximum temperature of 97° C. for 3 minutes with a biaxial open roll, to obtain uncured rubber compositions. The uncured rubber compositions obtained were rolled in a sheet shape with a mold and vulcanized by press under the condition of 170° C. for 12 minutes to prepare the vulcanized rubber sheets of Production Examples 6 to 9 (CA1 to 4).

### Production Examples 10 to 17

### Rubber Compositions for an Inner Liner

Chemicals excluding sulfur and a vulcanization accelerator were added and kneaded under the condition of a maximum temperature of 165° C. for 5 minutes with a Banbury mixer according to the compounding prescription shown in Table 3, to obtain kneaded articles. Then, sulfur and a vulcanization accelerator were added to the kneaded product obtained, and the mixture was kneaded under the condition of a maximum temperature of 97° C. for 3 minutes with an open roll, to obtain uncured rubber compositions. The uncured rubber compositions obtained were rolled in a sheet shape with a mold and vulcanized by press under the condition of 170° C. for 12 minutes to prepare the vulcanized rubber sheets of Production Examples 10 to 17 (IL1 to 8).

### (Viscoelasticity Test)

The complex elastic modulus (E*) and loss tangent (tan δ) of the cured rubber compositions was measured under the conditions of a temperature of 70° C., a frequency of 10 Hz, an initial stain of 10 and a dynamic strain of 2%, using a viscoelasticity spectrometer VES manufactured by Iwamoto Seisakusyo K.K. It is indicated that the lower the E* is, the lower the rolling resistance is in the rubber compositions for a side wall, a case and an inner liner. It is indicated that the smaller the tan δ is, the more the rolling resistance is reduced and the more superior the low fuel cost is.

### (Tensile Test)

Vulcanized rubber test pieces with a predetermined size were cut from the vulcanized rubber compositions and the elongation at break (EB) of each compounding was measured according to JIS K 6251 “Vulcanized rubber and thermoplastic rubber—Determination method of tensile property”. Further, it is indicated that the larger the EB is, the more the elongation at break and crack growth property after generation of crack is suppressed.

The evaluation results above are shown in Tables 1 to 3.

TABLE 1

| Rubber compositions for a side wall | | | | |
|---|---|---|---|---|
| Production | Production | Production | Production | Production |
| Example 1 | Example 2 | Example 3 | Example 4 | Example 5 |
| (SW1) | (SW2) | (SW3) | (SW4) | (SW5) |

Compounding amount (parts by weight)

| | | | | | |
|---|---|---|---|---|---|
| NR | 60 | 60 | 45 | 60 | 45 |
| Modified BR | 40 | 40 | — | 15 | 55 |
| BR | — | — | 55 | — | — |
| ENR | — | — | — | 25 | — |
| Carbon black 1 | 30 | — | 50 | 30 | 30 |
| Carbon black 2 | — | 30 | — | — | — |
| Zinc oxide | 4 | 4 | 4 | 4 | 4 |
| Stearic acid | 2 | 2 | 2 | 2 | 2 |
| Aromatic oil | 6 | 4 | 6 | 6 | 4 |
| Antioxidant | 3.5 | 3.5 | 3.5 | 3.5 | 3.5 |
| Wax | 1 | 1 | 1 | 1 | 1 |
| Insoluble sulfur | 2.0 | 2.0 | 1.6 | 2.0 | 2.0 |
| (Pure sulfur content) | (1.8) | (1.8) | (1.4) | (1.8) | (1.8) |
| Vulcanization accelerator CZ | 1.0 | 1.0 | 1.0 | 1.0 | 1.0 |

Evaluation result

| | | | | | |
|---|---|---|---|---|---|
| E* (70° C.) (MPa) | 2.5 | 2.5 | 3.7 | 2.6 | 2.7 |
| tanδ (70° C.) | 0.090 | 0.070 | 0.160 | 0.075 | 0.078 |
| EB (%) | 470 | 480 | 560 | 490 | 450 |

TABLE 2

| Rubber compositions for covering a case cord | | | |
|---|---|---|---|
| Production | Production | Production | Production |
| Example 6 | Example 7 | Example 8 | Example 9 |
| (CA1) | (CA2) | (CA3) | (CA4) |

Compounding amount (parts by weight)

| | | | | |
|---|---|---|---|---|
| NR | 60 | 60 | 70 | 70 |
| E-SBR | 25 | — | — | 30 |
| Modified S-SBR | — | 25 | — | — |
| ENR | — | — | 30 | — |
| Modified BR | 15 | 15 | — | — |
| Carbon black 3 | 35 | 35 | 35 | 47 |
| Zinc oxide | 4 | 4 | 4 | 4 |
| Stearic acid | 2 | 2 | 2 | 2 |
| Aromatic oil | 9 | 9 | 9 | 9 |
| Antioxidant | 1 | 1 | 1 | 1 |
| Insoluble sulfur | 3.3 | 3.3 | 3.3 | 3.3 |
| (Pure sulfur content) | (3.0) | (3.0) | (3.0) | (3.0) |
| Vulcanization | 1.0 | 1.0 | 1.0 | 1.0 |
| accelerator CZ | | | | |

Evaluation result

| | | | | |
|---|---|---|---|---|
| E* (70° C.) (MPa) | 3.0 | 2.8 | 2.6 | 4.7 |
| tanδ (70° C.) | 0.095 | 0.075 | 0.098 | 0.135 |
| EB (%) | 420 | 360 | 480 | 460 |

TABLE 3

| Rubber compositions for an inner liner | | | | | | | |
|---|---|---|---|---|---|---|---|
| Production | Production | Production | Production | Production | Production | Production | Production |
| Example 10 | Example 11 | Example 12 | Example 13 | Example 14 | Example 15 | Example 16 | Example 17 |
| (IL1) | (IL2) | (IL3) | (IL4) | (IL5) | (IL6) | (IL7) | (IL8) |

Compounding amount (parts by weight)

| | | | | | | | | |
|---|---|---|---|---|---|---|---|---|
| Butyl rubber | 50 | 50 | 50 | 50 | 80 | 70 | 50 | 50 |
| NR | 50 | 25 | 50 | 50 | 20 | 30 | 25 | 25 |
| Modified BR | — | 25 | — | — | — | — | 25 | 25 |
| Carbon black 2 | 25 | 25 | 25 | 25 | 70 | 35 | — | 15 |
| Carbon black 1 | — | — | — | — | — | — | 25 | — |
| Silica 1 | — | — | 10 | — | — | — | — | 10 |
| Silica 2 | — | — | — | 10 | — | — | — | — |
| Mica | 35 | 35 | 35 | 35 | — | 35 | 35 | 35 |
| Zinc oxide | 3 | 3 | 3 | 3 | 3 | 3 | 3 | 3 |
| Stearic acid | 1 | 1 | 1 | 1 | 1 | 1 | 1 | 1 |
| Aromatic oil | 12 | 12 | 12 | 12 | 12 | 12 | 12 | 12 |
| Antioxidant | 1 | 1 | 1 | 1 | 1 | 1 | 1 | 1 |
| 0.5% Oil treated | 0.6 | 0.6 | 0.6 | 0.6 | 0.6 | 0.6 | 0.6 | 0.6 |
| sulfur powder | | | | | | | | |
| Vulcanization | 0.7 | 0.7 | 0.7 | 0.7 | 1.2 | 0.7 | 0.7 | 0.7 |
| accelerator DM | | | | | | | | |
| Vulcanization | 1.2 | 1.2 | 1.2 | 1.2 | — | 1.2 | 1.2 | 1.2 |
| accelerator TBZTD | | | | | | | | |

Evaluation result

| | | | | | | | | |
|---|---|---|---|---|---|---|---|---|
| E* (70° C.) (MPa) | 3.0 | 3.0 | 3.8 | 3.7 | 5.2 | 2.8 | 3.4 | 2.7 |
| tanδ (70° C.) | 0.130 | 0.110 | 0.147 | 0.129 | 0.230 | 0.185 | 0.125 | 0.120 |
| EB (%) | 580 | 560 | 660 | 610 | 600 | 640 | 630 | 640 |

### Examples 1 to 10 and Comparative Examples 1 to 8

The unvulcanized rubber compositions for a side wall of Production Examples 1 to 5 were molded in a side wall shape. The unvulcanized rubber compositions for covering a case cord of Production Examples 6 to 9 were molded in a case shape by covering a cord (polyester cord manufactured by Teijin Limited). The unvulcanized rubber compositions for an inner liner of Production Examples 10 to 17 were molded in an inner liner shape. They were laminated with other tire members in a combination shown in Table 4, to form the unvulcanized tires of Examples 1 to 10 and Comparative Examples 1 to 8, and tires for test (195/65R15GT065 and a summer tire for a vehicle) were produced by vulcanizing them by press under the condition of 170° C. for 12 minutes.

### (Rolling Resistance)

The rolling resistance of the above tires for test under the conditions of rim size (15×6JJ), tire inner pressure (200 kPa), load (4.41 kN) and speed (80 km/h) was measured using a rolling resistance tester. Then, the rolling resistance index of the tire of Comparative Example 1 was referred to as 100 and the rolling resistance of respective compoundings was displayed by indices according to the following calculation formula. Further, it is indicated that the smaller the rolling resistance index is, the more the rolling resistance is reduced and the better the rolling resistance performance is.

(Rolling resistance index)=(Rolling resistance of each compounding)/(Rolling resistance of Comparative Example 1)×100

### (Drum Durability Index)

The tires ran on a drum at a speed of 20 km/h under the condition of the maximum load (maximum inner pressure condition) according to JIS Specification of 230% loading, and the durability of a side wall portion was determined by measuring running distance (running distance until the swelling generation of the side wall portion) in which the destruction of the interface between a case cord and a side wall is extended to grow in separation, referring the running distance of the tire of Comparative Examples 1 to 100 and displaying the running distance of each compounding with an index (drum durability index) respectively by the calculation formula below. The swelling of the side wall was generated when a circle or a semicircle swelling with a diameter of at least 5 cm was generated or a broken hole was generated at the side wall portion. Further, it is indicated that the larger the drum durability index is, the more superior in durability the side wall portion is and the better it is. In general, the larger the EB is and the smaller the tan δ is, the more hardly the separation occurs. Although the separation is not extended in the inner liner, the tan δ is affected by the temperature of the side wall portion; therefore it is engaged in durability next to the case and side wall.

(Drum durability index)=(Running distance of each compounding)/(Running distance of Comparative Example 1)×100

Evaluation result above is shown in Table 4.

TABLE 4

| Examples | | | | | | | | | | Comparative Examples | | | | | | | |
|---|---|---|---|---|---|---|---|---|---|---|---|---|---|---|---|---|---|
| 1 | 2 | 3 | 4 | 5 | 6 | 7 | 8 | 9 | 10 | 1 | 2 | 3 | 4 | 5 | 6 | 7 | 8 |

Rubber compositions used for each member

| | | | | | | | | | | | | | | | | | | |
|---|---|---|---|---|---|---|---|---|---|---|---|---|---|---|---|---|---|---|
| Side wall | SW1 | SW2 | SW1 | SW1 | SW4 | SW5 | SW1 | SW1 | SW1 | SW1 | SW3 | SW1 | SW3 | SW3 | SW1 | SW2 | SW1 | SW3 |
| portion | | | | | | | | | | | | | | | | | | |
| Case portion | CA1 | CA2 | CA3 | CA1 | CA1 | CA1 | CA1 | CA1 | CA1 | CA1 | CA4 | CA4 | CA1 | CA4 | CA1 | CA2 | CA4 | CA1 |
| Inner liner | IL1 | IL2 | IL1 | IL3 | IL1 | IL1 | IL6 | IL4 | IL7 | IL8 | IL3 | IL3 | IL3 | IL1 | IL5 | IL5 | IL1 | IL1 |
| portion | | | | | | | | | | | | | | | | | | |

Evaluation result

| | | | | | | | | | | | | | | | | | | |
|---|---|---|---|---|---|---|---|---|---|---|---|---|---|---|---|---|---|---|
| Rolling | 84 | 79 | 82 | 88 | 82 | 81 | 87 | 90 | 83 | 82 | 100 | 91 | 98 | 95 | 89 | 86 | 89 | 93 |
| resistance | | | | | | | | | | | | | | | | | | |
| Drum | 165 | 140 | 150 | 145 | 170 | 165 | 140 | 150 | 165 | 170 | 100 | 105 | 95 | 105 | 135 | 110 | 120 | 105 |
| durability index | | | | | | | | | | | | | | | | | | |

### INDUSTRIAL APPLICABILITY

According to the present invention, there can be provided a tire satisfying both of the reduction of rolling resistance and the improvement of tire strength by combining a side wall, a case and an inner liner including predetermined rubber compositions to prepare a tire.

1. A tire having a side wall, a case and an inner liner wherein
the side wall comprises (A) a rubber composition for a side wall comprising 20 to 45 parts by weight of (A2) filler
based on 100 parts by weight of a rubber component comprising 35 to 65% by weight of (A1) a natural rubber and/or an isoprene rubber and 15 to 55% by weight of a modified butadiene rubber,
the cord of the case is covered with (B) a rubber composition for covering a case cord comprising
20 to 45 parts by weight of (B2) filler
based on 100 parts by weight of (B) a rubber component comprising (B1) 50 to 80% by weight of a natural rubber and/or an isoprene rubber and 20 to 45% by weight of at least one diene rubber selected from a group comprising a modified styrene-butadiene rubber, a styrene-butadiene rubber by solution polymerization, a styrene-butadiene rubber by emulsion polymerization, a modified butadiene rubber and an epoxidized natural rubber, and
the inner liner comprises (C) a rubber composition for an inner liner comprising
15 to 45 parts by weight of (C2) carbon black with a nitrogen adsorption specific surface area of 20 to 45 m²/g, and
10 to 50 parts by weight of (C4) mica with an average particle diameter of 40 to 100 μm and an aspect ratio of 50 to 100
based on 100 parts by weight of a rubber component comprising 35 to 80% by weight of (C1) a butyl rubber.

2. The tire of claim 1, wherein
the complex elastic modulus E* measured is 2.5 to 3.5 MPa and the loss tangent tan δ is 0.03 to 0.100 at 70° C. of (A) the rubber composition for a side wall,
the complex elastic modulus E* measured is 2.5 to 3.5 MPa and the loss tangent tan δ is 0.03 to 0.100 at 70° C. of (B) the rubber composition for covering case cord, and
the complex elastic modulus E* measured is 2.5 to 5.0 MPa and the loss tangent tan δ is 0.05 to 0.185 at 70° C. of (C) the rubber composition for an inner liner.

3. The tire of claim 1, for a vehicle or a light autotruck.
